(19) United States
(12) Patent Application Publication
(10) Pub. No.: US 2017/0097065 A1
(43) Pub. Date: Apr. 6, 2017

(54) COMPONENT, USE OF A COMPONENT, AND METHOD FOR PRODUCING A WEAR-RESISTANT AND FRICTION-REDUCING COMPONENT

(71) Applicant: Schaeffler Technologies AG & Co. KG, Herzogenaurach (DE)

(72) Inventors: Romina Costa, Weisendorf (DE); Yashar Musayev, Nurnberg (DE); Edgar Schulz, Langensendelbach (DE); Tim Matthias Hosenfeldt, Nurnberg (DE); Bolko Schuseil, Hemhofen (DE)

(73) Assignee: Schaeffler Technologies AG & Co. KG, Herzogenaurach (DE)

(21) Appl. No.: 15/311,679

(22) PCT Filed: Feb. 5, 2015
(86) PCT No.: PCT/DE2015/200065

§ 371 Date: Nov. 16, 2016

(30) Foreign Application Priority Data
May 16, 2014 (DE) 10 2014 209 309.0

(51) Int. Cl. F16G 15/12; C23C 28/04

(52) U.S. Cl. CPC F16G 15/12; C23C 28/044; C23C 28/046

(57) ABSTRACT

A component is provided, in which at least one surface is at least partially provided with a layer system. According to the invention, the layer system is formed of a tetrahedral, hydrogen-free, amorphous first carbon layer applied to the at least one surface of the component, onto which first carbon layer a hydrogen-free amorphous second carbon layer is applied.

### BACKGROUND

The present invention relates to a component in which at least one surface is at least partly provided with a layer system.

The present invention also relates to the use of a component in which at least one surface is at least partly provided with a layer system.

The invention further relates to a process for producing a wear-resistant and friction-reducing component in which at least one surface is at least partly provided with a layer system.

Components of the type mentioned at the outset in which at least one surface is at least partly provided with a layer system are employed in various technical fields. Thus, layer systems which have tribological properties, e.g. wear resistance and friction-reducing functions, in order to ensure these properties for components, for example for highly stressed chain drive components, roller bearing components, engine elements and tools, are also known from the prior art.

To be able to ensure wear protection, such components, e.g. chain pins, are at present treated by a thermochemical treatment, for example by chrome diffusion or by heat treatment such as by carbonitriding for example and also by means of PVD coating with CrN. This is described, for example, in the German patent documents DE 10 2004 043 550 A1 and DE 10 2005 047 440 A1. However, these technologies are firstly not satisfactory for providing the components with reliable protection against wear with increasing stress and secondly they do not spare the friction partners of the components, which represent disadvantages.

### SUMMARY

It is therefore an object of the present invention to modify a component in which at least one surface is at least partly provided with a layer system in such a way that it is protected against tribological stress and, in particular, ensures reliable and ongoing wear protection.

This object is achieved by a component comprising one or more features of the invention.

A further object of the present invention is to indicate a use of a component in which at least one surface is at least partly provided with a layer system so that the component is protected against tribological stress during operation and, in particular, ensures reliable and ongoing wear protection.

This object is achieved by a use of a component which comprises one or more features of the invention.

A further object of the present invention is to provide a process which is suitable for mass production and reliable for producing a wear-resistant and friction-reducing component, which protects the component reliably and in an ongoing manner against tribological stress when the stress increases during operation.

This object is achieved by a process for producing a wear-resistant and friction-reducing component which comprises one more features of the invention.

In the component of the invention, at least one surface is at least partly provided with a layer system.

According to the invention, the layer system is composed of a tetrahedral water-free amorphous first carbon layer which is applied to the at least one surface of the component and onto which a water-free amorphous second carbon layer has been applied.

In particular, the first carbon layer is a very hard ta-C carbon layer and the second carbon layer is a tribologically graphite-like carbon layer. Described structurally, the first carbon layer is a ta-C sp3-bonded carbon layer and the second carbon layer is an a-C sp2-bonded carbon layer.

The total layer thickness of the layer system is preferably from 0.5 to 5 μm. Accordingly, special attention does not have to be paid to available construction space. At the indicated layer thickness, the tribological properties can therefore be set in a very wide range as a function of the sp3 proportion and sp2 proportion.

In a first embodiment of the component of the invention, a bonding layer has been applied at least to the at least one surface of the component before application of the first carbon layer.

In a further embodiment of the invention, at least one metal and/or at least one nonmetal has been introduced as dopant into the layer system in order to be able to modify the properties of the two carbon layers according to requirements and the particular application. As a result of introduction of metal as dopant into a carbon layer, these layer systems then have, for example, high wear resistances, low coefficients of friction and also better adhesion of the layers to one another. This means that the materials properties of the layer systems can be greatly influenced by a change in the metal content. However, it is likewise conceivable for these carbon layers to be doped with elements such as, for example, silicon, oxygen, etc. Silicon, for example, increases the heat resistance in an oxygen-containing environment. Doping with silicon and oxygen enables the surface energy to be greatly reduced (down to values in the order of magnitude of PTFE). Furthermore, transparent and extremely scratch-resistant layers can be produced.

The process of the invention for producing a wear-resistant and friction-reducing component, in which at least one surface is at least partly provided with a layer system, is characterized according to the invention by the following steps: In a first step, a tetrahedral water-free amorphous first carbon layer which is a ta-C sp3-bonded carbon layer is deposited on the at least one surface of the component. In a subsequent step, a water-free amorphous second carbon layer which is an a-C sp2-bonded carbon layer is deposited on the first carbon layer.

A first embodiment of the process of the invention can also provide for a bonding layer to be applied at least to the at least one surface of the component before deposition of the first carbon layer.

Furthermore, a further embodiment of the process of the invention can provide for at least one metal and/or at least one nonmetal to be introduced as dopant into the layer system in order to match the layer system to the respective use (variation of the hardness and the tribological properties of the coating).

The above-described layer system consisting of the sp3- and sp2-bonded carbon layers provides excellent tribological properties. In addition, this layer system ensures reliable and ongoing wear protection for the component. The invention can thus also be employed for highly stressed machine elements. These include, for example, chain pins and further roller bearing components and also highly stressed engine components such as bucket tappets, pump tappets, rocker arms, control pistons of a diesel injection pump, etc. A further advantage of the invention is that the two carbon layers described here can be realized easily and economically from a plant technology (e.g.: in-line plant) and process technology point of view within the formation of the layer system, so that the invention provides a production process which is suitable for mass production and reliable for a wear-resistant and friction-reducing component.

### BRIEF DESCRIPTION OF THE DRAWINGS

Illustrative embodiments provide a more detailed explanation of the invention and its advantages below with the aid of the accompanying figures. The relative sizes in the figures do not always correspond to the actual relative sizes since some shapes are simplified and other shapes are enlarged relative to other elements in the interests of clarity. The figures show:

FIG. 1 a side elevation of the component according to the invention in which a surface has been at least partly provided with a layer system;

FIG. 2 a side elevation of the layer system of FIG. 1;

FIG. 3 a graph which shows the mechanical-technological properties of layer systems which can be employed for the present invention;

FIG. 4 a graph which shows the coefficient of friction in a ball-on-disc tribometer of various carbon layers which can be employed for a layer system according to the present invention; and

FIG. 5 a graph which shows the degree of wear in a ball-on-disc tribometer of various carbon layers which can be employed for a layer system according to the present invention.

### DETAILED DESCRIPTION OF THE PREFERRED EMBODIMENTS

Identical reference symbols are used for elements which are the same or have the same effect. Furthermore, in the interests of clarity, only reference symbols which are necessary for the description of the respective figure are shown in the individual figures. The embodiments presented are merely examples of how the component of the invention, the use according to the invention of a component and the process of the invention for producing a wear-resistant and friction-reducing component can be configured and thus do not represent a definitive limitation of the invention.

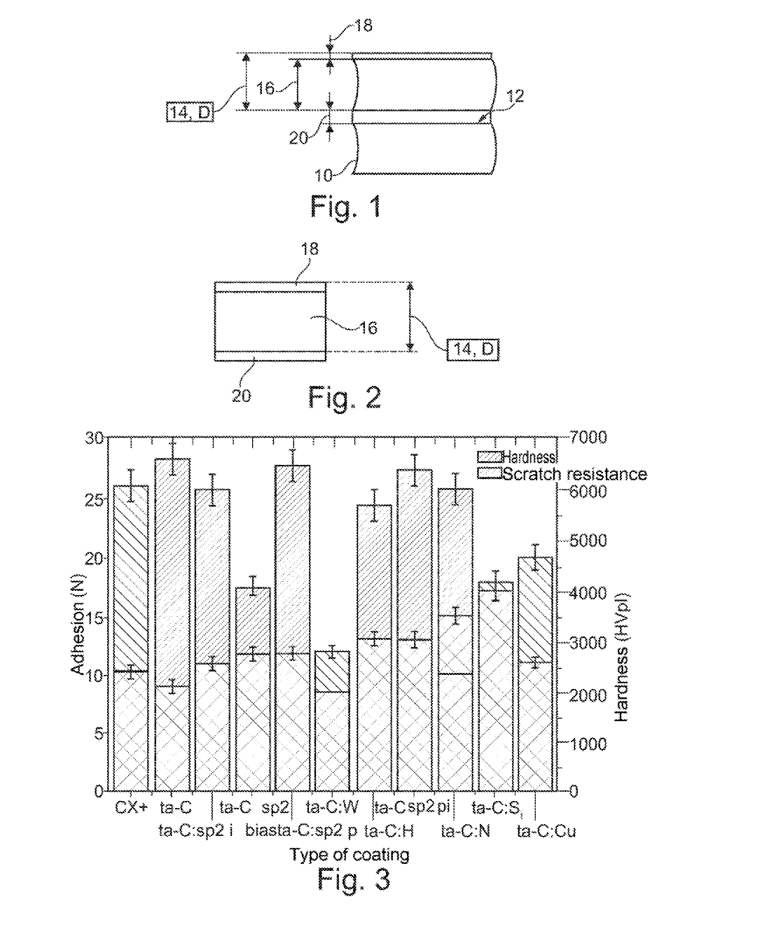

FIG. 1 shows a side elevation of the component 10 according to the invention in which a surface 12 is at least partly provided with a layer system 14. According to the invention, the layer system 14 is formed of a tetrahedral water-free amorphous first carbon layer 16 which has been applied to the surface 12 of the component 10 and on top of which a water-free amorphous second carbon layer 18 has been applied. The layer system 14 formed by the two carbon layers 16, 18 preferably has a total layer thickness D of from 0.5 to 5 μm.

In the embodiment shown here, a bonding layer 20 has been applied to the surface 12 of the component 10 before application of the first carbon layer 16, so that better adhesion is ensured.

FIG. 2 shows a side elevation of the layer system 14 including the first (ta-C sp3-bonded) carbon layer 16 and the second (a-C sp2-bonded) carbon layer 18, with a bonding layer 20 being applied to the surface 12 of the component 10 of FIG. 1 before application of the first carbon layer 16.

FIG. 3 shows a graph which indicates mechanical-technological properties with respect of adhesion and hardness of layer systems 14 which can be employed for the present invention. Thus, for example, the first carbon layer 16 (see FIG. 1) can be doped with at least one metal, for example copper (Cu), and/or at least one nonmetal, for example silicon (Si), in order to be able to modify the properties of the layer 14 according to requirements and the particular use.

FIG. 4 shows a graph which indicates the coefficient of friction in a ball-on-disc tribometer of various carbon layers which can be employed for a layer system 14 as per FIGS. 1 and 2 for the present invention, i.e. oils (X axis) are altered in order to be able to evaluate the influence on the friction behavior of the respective carbon layer. Depending on the particular use of the component 10 (see FIG. 1) and the stress to which it is subjected during operation, it is thus possible to select a layer which then satisfies the desired tribological properties for the component 10.

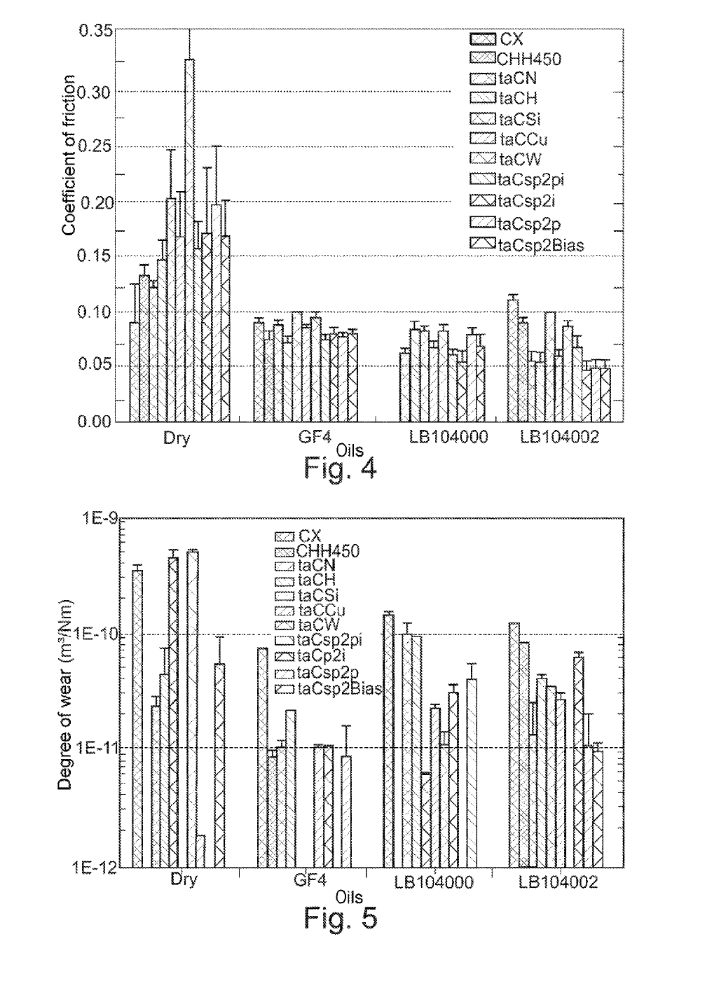

FIG. 5 shows a graph which indicates the degree of wear in the ball-on-disc tribometer of various carbon layers which can be employed for a layer system 14 as per FIGS. 1 and 2 for the present invention, i.e. oils (X axis) are altered here in order to be able to evaluate the influence on the wear behavior of the respective carbon layer. Here too, depending on the particular use of the component 10 (see FIG. 1) and the stress to which it is subjected during operation, it is possible to select a layer which then satisfies the desired tribological properties for the component 10.

### LIST OF REFERENCE SYMBOLS

10 Component
12 Surface
14 Layer system
16 Tetrahedral water-free amorphous first carbon layer, ta-C sp3-bonded carbon layer
18 Water-free amorphous second carbon layer; a-C sp2-bonded carbon layer
20 Bonding layer
D Total layer thickness

1. A component comprising at least one surface at least partly provided with a layer system, (14), the layer system is comprised of a tetrahedral water-free amorphous first carbon layer applied to the at least one surface of the component and on top of which a water-free amorphous second carbon layer has been applied,
the first carbon layer is a ta-C sp3-bonded carbon layer and the second carbon layer is an a-C sp2-bonded carbon layer, and
at least one of a metal or a nonmetal is introduced as dopant into the layer system, and the nonmetal is selected from the group consisting of silicon and nitrogen.

2. The component as claimed in claim 1, wherein a total layer thickness (D) of the layer system is from 0.5 to 5 μm.

3. The component as claimed in claim 1 further comprising a bonding layer applied at least to the at least one surface of the component before application of the first carbon layer.

4. The component as claimed in claim 1, wherein the dopant comprises at least one metal from the group consisting of copper and tungsten.

5. A method for reducing wear between friction partners, comprising: providing component with the at least one surface that is at least partly provided with the layer system as claimed in claim 1, and moving the component in a wear-resistant and friction-reducing manner on a friction partner.

6. A process for producing a wear-resistant and friction-reducing component, in which at least one surface is at least partly provided with a layer system, characterized by comprising the following steps:
depositing a tetrahedral water-free amorphous first carbon layer in the form of a ta-C sp3-bonded carbon layer on top of the at least one surface of the component; and
depositing a water-free amorphous second carbon layer in the form of an a-c sp2-bonded carbon layer on top of the first carbon layer; and
introducing at least one of a metal or nonmetal as dopant into the layer system being deposited, with the nonmetal being selected from the group consisting of silicon and nitrogen.

7. The process as claimed in claim 6, further comprising providing a bonding layer at least to the at least one surface of the component before deposition of the first carbon layer.

8. (canceled)

9. The component as claimed in claim 1, wherein the dopant comprises at least one of copper or silicon.

10. The component as claimed in claim 1, wherein the dopant comprises nitrogen.

11. The component as claimed in claim 1, wherein the component is a chain pin.
